(19) United States
(12) Patent Application Publication
(10) Pub. No.: US 2007/0036110 A1
(43) Pub. Date: Feb. 15, 2007

(54) Access control of mobile equipment to an IP communication network with dynamic modification of the access policies

(75) Inventor: Christophe Preguica, Versailles (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/500,336

(22) Filed: Aug. 8, 2006

(30) Foreign Application Priority Data
Aug. 10, 2005 (FR) 0552484

(51) Int. Cl. H04Q 7/00

(52) U.S. Cl. 370/331

(57) ABSTRACT

Access equipment (E_{A}) to a communication network (N), equipped with a radio-communication interface (I_{R}) capable of transmitting packets to mobile hosts (H₁, H₂, H₃) located in a geographical zone (Z) linked to the interface, negotiation means intended to set up an exchange of data packets with a host of this zone, requesting access to the network, and transmission means to allow a data flow between one or multiple remote equipments (ED) situated in the communication network and the hosts recorded on the list of authorized mobile hosts, wherein the transmission means do not transmit any data packets to or from hosts not recorded on the list. This equipment is characterized by the fact that the negotiation means comprise control means intended to authenticate the host on the basis of the exchange of data packets and to modify the list in function of this authentication.

### BACKGROUND OF THE INVENTION

The present invention is related to the field of access control to a communication network using IP (Internet Protocol). It is particularly suited for radio access to such networks.

Indeed, within the scope of radio access to a communication network there is no predetermined connection between the access equipments and the hosts. These hosts are mobile equipments that are capable of communicating with a network using the IP protocol. They may include amongst others terminals such as mobile communication terminals of type GSM, UMTS, CDMA etc. portable computers, personal digital assistants (PDAs), etc.

Because of the mobility of the hosts (and possibly of the access equipments), the latter cannot be permanently linked to access equipment as is usually the case in a fixed communication network. A new host or a host having moved to the coverage zone of access equipment must therefore connect dynamically to this access equipment.

This dynamic connection generates various types of problems linked to access control.

This access control requirement applies in various contexts. For instance, it must be possible to prevent a company visitor using mobile equipment from freely obtaining access to the company's local network. It is also important to prevent a malicious third party from connecting to a communication network in order to gain access to sensitive information or to harm the integrity of the network.

Thus, from the standpoint of the access equipment, it is necessary to check the host's identity in order to determine whether he may indeed be connected to the communication network, and if this is the case determine his rights in this network. Conversely, the host must also check the identity of the access equipment to which he wishes to be connected.

Document P802.1X promoted by the IEEE proposes an access control solution entitled <<Draft Standard for Port Based Network Access Control >>. It defines a mechanism using the physical access characteristics of the local network infrastructures or LAN (Local-Area Network) defined by the standards of the IEEE 802 family. It also allows to authenticate the hosts linked to a LAN port in <<point to point >> mode and to prevent access and transmission on this port if authentication is not ensured.

However, this mechanism entails many disadvantages.

First, it focuses on the equipment ports and is thus located on the second layer of the OSI (Open System Interconnect) layer model promoted by the ISO (International Standards Organization). This second layer called the <<Data Link Layer>> concerns the interface of the communication equipments. This layer is dependent on the technology implemented to set up the connection.

However, we have seen that a host and access equipment can be connected by means of various technologies. Without claiming to provide an exhaustive list, we can quote mobile telephone standards such as GSM, UMTS, and also WiFi, Ethernet, Blue Tooth, Wimax . . .

The WiFi standard defined in standards IEEE 802.11, the <<Bluetooth )>> technology defined in standards IEEE 802.15, the WiMAX (Worldwide Interoperability for Microwave ACCess) technology defined in standard IEEE 802.13, for instance, all have different data connection techniques. Also within the same technology family various versions can co-exist and entail different data connection techniques.

Consequently, mechanism P802.1X has the major disadvantage of requiring as many implementations as there are technologies supported by the system. This obviously entails a considerable increase in the system cost as well as an increased use of the available resources.

A second disadvantage is that it requires a dedicated authentication server. This authentication server can communicate with the access equipment via the AAA (Authentication Authorization Accounting) protocol defined by the RFC 2906 of the IETF. Alternately, a RADIUS <<Remote Authentication Dial In User Service) server may be used as defined by the RFC 2865 of the IETF.

In this instance also, the essential use of a dedicated server makes the system very costly, especially in a heterogeneous environment since the nature of the information required for the authentication is different for each type of server.

### SUMMARY OF THE INVENTION

The invention is intended to resolve the different technical problems. Its object is an access equipment to a communication network equipped with a radio-communication interface capable of exchanging data packets with mobile hosts located in a geographical zone linked to this interface, negotiation means intended to set up an exchange of data packets with a mobile host of the geographical zone requesting access to the relevant communication network and transmission means for transmitting data packets forming a data flow between one or more remote equipments located in the communication network and the mobile hosts recorded on a list of authorized mobile hosts stored in the access equipment, wherein the transmission means do not transmit any data packet to or from mobile hosts not recorded in the list of authorized mobile hosts.

The access equipment of the invention is characterized by the fact that the negotiation means comprise control means intended to authenticate the mobile host based on the exchange of the data packets and to modify the list of authorized mobile hosts in function of this authentication.

Depending on the implementation of the invention the latter may include one or more of the following characteristics:

the list of authorized mobile hosts is an ACL (Access Control List) type database,

the negotiation means transmit an advertisement message to the mobile host containing the authentication status,

the exchange of data packets comprises a solicitation message containing a certificate including the information that is necessary and sufficient to allow the authentication,

the control means are provided to access the public key of a trustworthy third party, this information that is necessary and sufficient to allow the authentication comprises reduced information encrypted by the private key of the trustworthy third party.

Moreover, the invention is also intended to provide a process for controlling the access of mobile hosts to a communication network via access equipment equipped with a radio-communication interface capable of exchanging data packets with one of the mobile hosts when the latter is located in a geographical zone linked to the access equipment.

The process comprises a data packet exchange step between the above-mentioned access equipment and the mobile hosts and a transmission step consisting in transmitting via the access equipment data packets forming a data flow between one or multiple remote equipments located in the communication network and the mobile hosts if and only if the latter have been recorded in a list of authorized mobile hosts stored in the access equipment.

This process is characterized by the fact that prior to the transmission step the access equipment authenticates each mobile host requesting access to the communication network on the basis of this data packet exchange step and modifies the list of the authorized mobile hosts in function of this authentication.

### BRIEF DESCRIPTION OF THE DRAWINGS

The invention and its benefits will become clear in the following description and in relation to the annexed figures.

FIG. 1 represents the context of the present invention.

FIG. 2 is a functional diagram of access equipment in compliance with the invention.

FIG. 3 illustrates the exchange of data packets between a mobile host and the access equipment according to the invention.

### DETAILED DESCRIPTION OF THE INVENTION

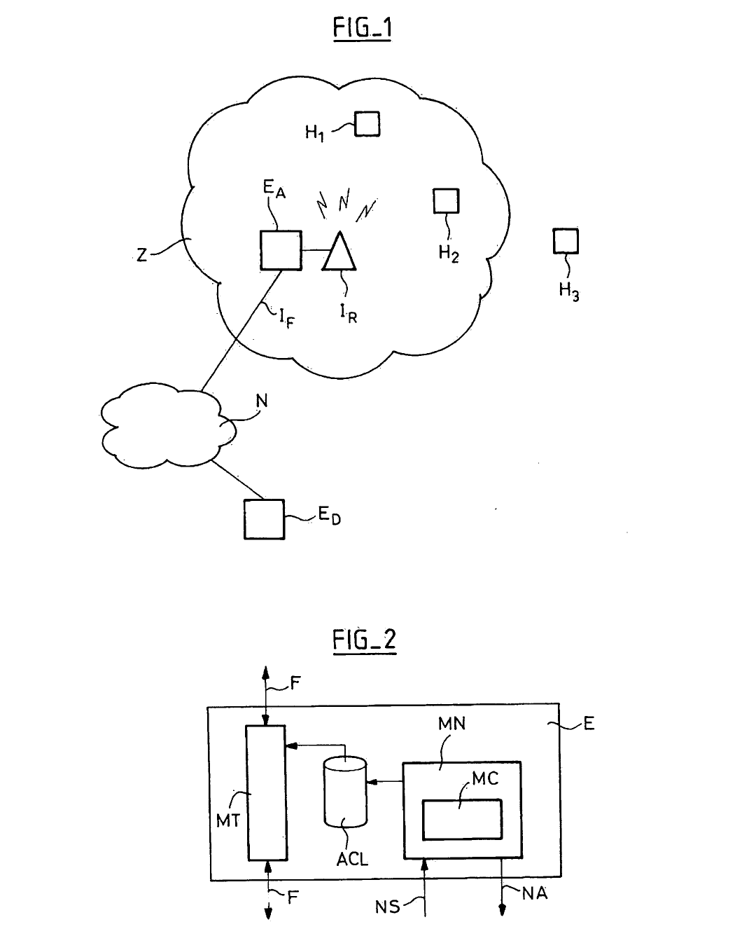

As shown in FIG. 1, access equipment EA has a radio interface Iᵣ. This interface is linked to a geographical zone Z (also called <<coverage>>) whose technical characteristics correspond to the type of technology implemented.

This may be a few tens of metres for a Bluetooth™ radio interface, a few hundreds of metres with WiFi or even a few kilometres with a WiMAX radio interface.

This geographical zone Z is represented in FIG. 1 as being approximately circular, whereas in fact this zone is more or less dependent on the obstacles of the terrain.

It should also be noted that the same access equipment EA may have multiple radio interfaces in order to be able to transmit using multiple radio-communication technologies.

Access equipment E_{A} also has a wire interface I_{F} with a fixed communication network N to which one or several remote equipments E_{D} are linked.

Mobile hosts H₁, H₂, H₃ may evolve in space and at a given moment be in zone Z linked to radio interface I_{R} of access equipment E_{A}. As stated above, these mobile hosts may be mobile radio-communication terminals, personal digital assistants (PDAs), portable computers equipped with a radio interface, etc.

In the example in FIG. 1, mobile hosts H₁ and H₂ are in this geographical zone Z. Mobile host H₃ is situated outside this geographical zone Z and is unable therefore to communicate physically with access equipment E_{A}.

When a mobile host is in geographical zone Z, it is able to request access to communication network N, amongst others to communicate with remote equipment E_{D}. This remote equipment E_{D} may be a host with which it wishes to exchange information (e.g. a phone or video call). It may also be a video server or a gateway to another network (not shown in the figure).

The data packets exchanged between the mobile hosts and access equipment E_{A} may comply with the IP protocol and preferably with protocol IPv6 (Internet Protocol—version 6). In that case, the access equipment EA includes an IP packet router.

It is known to incorporate access equipment, a list of authorized hosts. According to the invention this list should preferably comply with the ACL (Access Control List) technology. This is a list of the identifiers of the hosts authorized to connect to equipment. This technology has not been the object of standardization works but is widely used by the equipment manufacturers.

The request to access communication network N occurs by exchanging data packets between mobile host H₁, H₂ requesting access and access equipment E_{A} to communication network N.

If the access request is successful the host is added to the authorized mobile hosts list, stored inside access equipment E_{A}.

Access equipment E_{A} can then transmit data flows between these two parties.

These data flows are presented as data packet sets. The latter can be unidirectional or bidirectional.

The data packets belonging to a data flow contain a source address and a destination address allowing to route them via communication network N. This information is contained in a heading that is clearly distinct from the useful data conveyed by the packet.

FIG. 2 gives a more detailed representation of the possible functional architecture of access equipment EA.

It has transmission means MT provided to allow data flows F between the communication network and the mobile host (not shown). This transmission may occur in both directions as stated above.

These transmission means MT indeed transmit the data flows provided the mobile host has been authenticated beforehand.

An ACL list of authorized mobile hosts is thus provided in access equipment E_{A}. Consequently, if a mobile host does not belong to the ACL list, transmission means MT will not transmit any packet flows to or from it. It will then be completely disconnected from the communication network. On the contrary, if the mobile host belongs to the ACL list then the transmission of data flows F is possible.

According to the invention this ACL list of authorized mobile hosts is initially empty. In this state no mobile host is capable of transmitting data flows with the communication network.

Each mobile host requesting access to the communication network exchanges data packets NS, NA with negotiation means MN contained in access equipment E_{A}.

Thanks to this exchange, the mobile host transmits information to negotiation means MN allowing access equipment E_{A} to authenticate it.

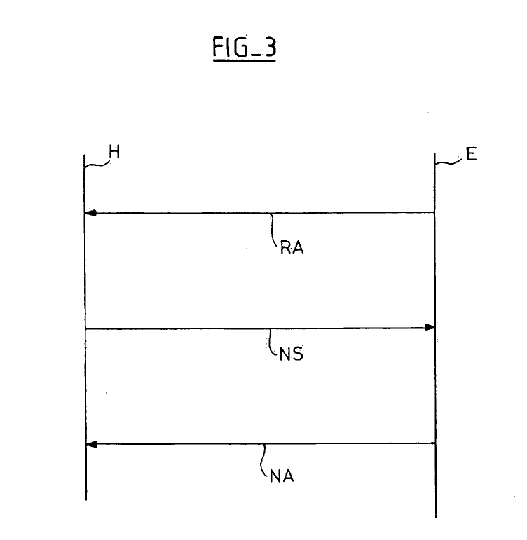

The relevant exchange is illustrated in FIG. 3 in the form of a vertical timing diagram. The time is oriented from top to bottom and the arrows indicate the transmission direction of the various messages sent between a mobile host H (on the left) and access equipment E_{A} (on the right).

In a first step the access equipment transmits a message RA to host H. This advertisement message RA is a Router Advertisement allowing equipment complying with protocol IP to announce its existence to its environment. It is thanks to the periodic transmission of this RA advertisement message in multi-cast mode that the mobile host can be informed of the presence of access equipment E_{A} in its vicinity (or rather that it is in geographical zone Z linked to access equipment E_{A}). The advertisement message RA especially includes a list of one or several subnet prefixes that are advertised by the router of the access equipment EA.

The format and the type of information sent in advertisement messages RA are defined in RCF 2461 of the IETF, entitled <<Neighbor Discovery for IP Version 6 (IPv6) that describes the NDP (Neighbor Discovery Protocol).

Mobile host H then sends a solicitation message NS (Neighbor Solicitation). Such a message complies with RFC 2461 previously mentioned.

Consequently, the format of the information contained complies with standard ICMPv6, i.e. according to a TLV formalism, <<Type, Length, Value>>.

Solicitation message NS comprises a header and possible a set of options. This header is a header that is specific to protocol NDP, which is distinct from the IP header that starts every IP packet. This NDP header comprises

a <<type >> field with value <<135 >> for an NS solicitation message of type <<Neighbor Solicitation Message>>.

a <<Code>> field with value <<0>>

a <<checksum>> field, in compliance with standard ICMPv6 and allowing to control the integrity of the solicitation message content.

A <<Reserved>> field not used by this type of message.

A <<target address>> field indicating the IP address of the addressee of the solicitation message. This is the IP address of access equipment E_{A} known to host H thanks to the RA advertisement message received by the latter.

Possibly one or more <<Options>> fields.

Various options have been defined. The option <<Source Link-layer address>> has been defined in this RFC 2461.

The RFC 3971 entitled <<Secure Neighbor Discovery (SEND)>> defines other options, namely:

<<CGA option>>

<<RSA signature option>>.

The RSA (for Rivest, Shamir and Adleman, the names of the inventors) encryption method is characterized by the fact that a different key is used for decryption and encryption. This method thus allows to use a <<public>> key for encrypting and a <<private>> key for decrypting. As explained in detail in RFC 3971, host H uses its own private key to encrypt a set of data (IP addresses, solicitation message headers, etc.) and to thus create his <<signature>>. This signature is inserted last in the <<RSA signature option>> field in the construction of the message.

Field <<CGA Option>> includes the CGA parameters data structure as defined in RFC 3972, i.e. in particular a modifier value, the subnet prefix of the IPv6 address of mobile host H, a collision count value and the public key used for cryptographically generating the IPv6 address in accordance with the CGA method. The CGA method enables the mobile host H to generate the interface identifier of its IPv6 address by computing a cryptographic hash of the public key belonging to the host.

According to the invention, a <<Certificates>> option is added to the NS solicitation messages.

It allows host H to transmit to negotiation means MN of access equipment E_{A} information allowing to authenticate it.

This certificate may include an identifier of host H, signed by a trustworthy third party. It may e.g. contain its IP address.

This certificate may comply with recommendation X.509 of the ITU-T (International Telecommunication Union), entitled <<Information technology—Open systems interconnection—The Directory: Public-Key and attribute certificate frameworks>> and be based on the works of the IETF (Internet Engineering Task Force) intended to adapt this recommendation for the protocols of the IP stack. These works were concretized in various RFC and <<Internet drafts>> and are regrouped in working group PKIX (for Public-Key Infrastructure (X.509)) set up in the autumn of 1995. The first of the normative documents defined by the PKIX working group is document RFC 2459 entitled <<Public Key Infrastructure Certificate and CRL Profiles>>

This certificate is preferably signed using the private key of the trustworthy third party (or CA for <<Certificate Authority>>) linked to mobile host H. Typically an algorithm is applied to the certificate to provide reduced information. This reduced information may then be encrypted by this private key of the trustworthy third party, subsequently the reduced information and the encrypted reduced information are attached to the certificate in the <<Certificate>> option before being sent in the NS solicitation message.

For example, mobile host H transmits in the “Certificates” option of the solicitation message NS at least one certificate including a serial number of the certificate, the name of the certificate authorizer, the term of validity of the certificate, the name of the certificate holder (which may be an individual or legal entity), the public key of the certificate holder, a designation of the signature algorithm used by the certificate authorizer and at least one signature of the authorizer. A certificate may also carry a plurality of digital signatures by several certificate authorizers, which may be organized e.g. as a tree or hierarchy. A single solicitation message Ns may also contain a plurality of certificates with the above format or similar formats so as to designate a plurality of certificate authorizers.

Upon receipt of solicitation message NS, control means MC can verify the contents of the latter. More specifically, they can verify whether options <<CGA option)>> and <<RSA signature option>> comply with the requirements of the SEND protocol defined in RFC 3971. When the “CGA” option is used, the control means proceed with verifying the association between the IPv6 address of host H and its public key. The verification method is described in RFC 3972.

Moreover, negotiation means MN verify the certificate or certificates contained in the <<Certificates>> option, by means of control means MC.

For that purpose, access equipment EA has a list of trustworthy third-parties, e.g. configured by the network administrator, which defines the certificate authorizers that the access equipment accepts. In the “Certificate” option of the solicitation message received, the control means MC search for a certificate released by a certificate authorizer belonging to the list of trustworthy third-parties. If one is present, this means that a certificate authorizer is recognized by both the host H and the access equipment EA. The existence of this shared trustworthy third-party is mandatory for the access procedure to continue. Then, the corresponding certificate is read in order to extract the public key of the mobile host. The control means MC use this public key for verifying the signature attached in the “RSA signature” option when this option is used.

In a situation in which the <<Certificates>> option is signed in the manner stated above, control means MC use the public key of the trustworthy third party to decrypt the encrypted reduced information to check the validity of the certificate. The result of the decryption of the encrypted reduced information must normally produce the reduced information also transmitted in the <<Certificate>> option.

If this is indeed the case, control means MC may be certain that the certificate was indeed signed by this trustworthy third party. Solicitation message NS is then authenticated. If this is not the case, it is not authenticated and must be rejected.

In order to decrypt the encrypted reduced information, control means MC must have access to the public key of the trustworthy third party used by mobile host H. This public key may already be made available to control means MC. It may also need to access a database of the trustworthy third party accessible on communication network N.

Various embodiments are then possible depending on the implemented PKI (Public Key Infrastructure). The work of the PKI working group allows many options and at present no possible infrastructure takes precedence over the others.

Consequently, the invention must not be limited to any one of these PKI infrastructures nor to the examples stated above.

In a preferred embodiment, options “RSA signature”, “CGA” and “Certificates” are used in a combined manner for authenticating host H. Thus, the certificate makes it possible to know the name of the authorized holder of the pair of private and public keys. The digital signature makes it possible to ascertain that the solicitation message NS was really sent by the key pair holder, who should be the only person to know the private key. The cryptographically generated address makes it possible to ascertain that the holder of this IP address is the same person as the authorized holder of the public key. The combined checking sets up a trustworthy association between the person named in the certificate and the IP address of the mobile terminal.

Depending on the options used in solicitation message NS, there exists a variety of situations that can bring the authentication process to failure and rejection of host H. Thus, with the combination of three options, the authentication fails as soon as the control means MC detect any one of the conditions here-below:

The certificate is not recognized as it is not authorized by a trustworthy third-party.

The certificate is recognized, yet is not valid.

The verification of the digital signature of host H fails.

The verification of the association between the IPv6 address and the public key of host H fails.

In a specific implementation of the invention, once mobile host H has been authenticated, control means MC can verify the access rights of mobile host H.

Indeed, a mobile host H can be authenticated but may not necessarily be granted all access rights. In certain cases, his authentication may entail a rejection of his request. In this case if he has been <<blacklisted>>, he may also only be granted limited access rights (to part of the network, to part of the services available on the network, etc.).

If control means MC authenticate host H as being entitled to access the communication network, it then modifies the list of authorized mobile hosts. This modification may consist in adding the IP address of host H to the ACL database. Thus each packet received by transmission means MT having this IP address as a source address will be sent to the communication network, and each packet having this IP address as a destination address will be sent by the transmission means MT towards host H.

Moreover, preferably, negotiation means MN return an advertisement message NA to mobile host H to inform it of the status of its request.

This advertisement message NA may be of type <<Neighbor Solicitation>> as defined in the RFC 2461 of the IETF (paragraph 4.4). The format of this <<(Neighbor Advertisement>> advertisement message is similar to that of solicitation message NS <<Neighbor Solicitation>> described above.

An additional <<Policy Notification Option>> option may be used to transmit a status of the solicitation sent by solicitation message NS.

This option could for instance have three values:

<<0>>, if the certificate is accepted by access equipment E_{A}, and if the access to the network is granted.

<<1>>, if the certificate could not be evaluated by access equipment E_{A}, e.g. because it is of an unknown type.

<<2>>, if the access request is rejected by access equipment E_{A}.

In this way, upon receipt of advertisement message NA, host H is informed whether it must transmit a new certificate (instance in which the option is <<1>>) or whether or not its packets will be sent by the access equipment. Depending on this, it can decide to choose another access equipment possibly located in geographical zone Z, or to inform the user that he is refused access to the communication network.

By using SEND protocol, access equipment EA can also transmit the information enabling host H to authenticate access equipment EA in an advertisement message NA (Neighbor advertisement). By way of example, the “RSA signature” and “CGA” options can be used in a similar manner in the opposite direction. Thus, SEND protocol messages can be used in both directions for the mutual authentication of access equipment EA and mobile host H.

The negotiation means and the control means can be implemented in hardware, software, or hardware and software. The negotiation means and the control means can be advantageously implemented through at least one software program like C, C++ or Java running on at least one hardware and performing the recited functions. The list of programming languages is exemplary and not exhaustive. The negotiation means and the control means can be implemented in a collocated manner or in a distributed manner, i.e. with the help of several hardware elements that cooperate to perform the recited functions. A suitable hardware includes means like an Application Specific Integrated Circuit (ASIC), a Field Programmable Gate Array (FPGA) and/or a microprocessor.

1) Access equipment (E_{A}) to a communication network (N), equipped with a radio-communication interface (I_{R}) capable of exchanging data packets with mobile hosts (H₁, H₂, H₃) located in a geographical zone (Z) linked to the relevant interface (I_{R}), negotiation means (MN) intended to set up an exchange of data packets (RA, NS, NA) with a mobile host in the relevant geographical zone requesting access to said communication network, and transmission means (MT) to transmit data packets forming a data flow (F), between one or more remote equipments (E_{D}) located in said communication network and the mobile hosts recorded in a list of authorized mobile hosts (ACL) stored in said access equipment, wherein said transmission means do not transmit any data packet to or from mobile hosts not recorded on said list of authorized mobile hosts, characterized by the fact that these negotiation means are capable of receiving from said mobile host a solicitation message (NS) containing a digital signature obtained by means of a private key associated to a public key, an IP address of the mobile host generated with the public key and a certificate digitally signed by at least one certificate authorizer, the certificate including the public key and a holder name of the public and private key pair, said negotiation means comprising control means (MC) capable of verifying the digital signature of the certificate authorizer, and then verifying the digital signature and the IP address of the mobile host with the public key received in the certificate, in order to authenticate the mobile host, the control means (MC) being capable of modifying the list of authorized mobile hosts in function of the authentication.

2) Access equipment according to claim 1, wherein said list of authorized mobile hosts is an ACL type database.

3) Access equipment according to claim 1, wherein said negotiation means are capable of transmitting an advertisement message (NA) to said mobile host containing the status of the relevant authentication.

4) Access equipment according to claim 3, wherein the authentication status contained in the advertisement message has a first value when the certificate is accepted by the access equipment, a second value when the certificate could not be evaluated by the access equipment, and a third value when the access request is rejected by the access equipment.

5) Access equipment according to claim 1, wherein said solicitation message comprises reduced information encrypted by the private key of the certificate authorizer and said non-encrypted reduced information, said control means being capable of using the public key of the certificate authorizer to decrypt the encrypted reduced information and compare the decrypted reduced information with said non-encrypted reduced information.

6) Access equipment according to claim 1, wherein the control means (MC) are capable of determining if said at least one certificate authorizer is a trustworthy third-party recognized by the access equipment and of refusing the authentication if not.

7) Access equipment according to claim 1, wherein the IP address is obtained with the CGA method according to RFC 3972.

8) Process for controlling the access of mobile hosts (H₁, H₂, H₃) to a communication network (N) via access equipment (EA) equipped with a radio-communication interface (I_{R}) capable of exchanging data packets with one of said mobile hosts when the latter is located in a geographical zone (Z) linked to said access equipment (E_{A}), said process comprising a data packet exchange step (RA, NS, NA) between said access equipment and said mobile hosts and a transmission step consisting in transmitting data packets forming data flows (F) via said access equipment between one or multiple remote equipments (E_{D}) located in said communication network and said mobile hosts if and only if the latter have been previously recorded on a list of authorized mobile hosts (ACL) stored in said access equipment, characterized by the fact that, prior to said transmission step the access equipment receives from a mobile host requesting access to the communication network a solicitation message (NS) containing a digital signature obtained by means of a private key associated to a public key, an IP address generated with the public key and a certificate digitally signed by at least one certificate authorizer, the certificate including the public key and a holder name of the public and private key pair, proceeds with the authentication of said mobile host soliciting access to the communication network, by verifying the digital signature and the IP address with the help of the public key received in the certificate, and modifies said list of authorized mobile hosts in function of this authentication.
